(19) United States
(12) Patent Application Publication
(10) Pub. No.: US 2026/0300171 A1
(43) Pub. Date: Oct. 1, 2026

(54) METHOD, DEVICE, AND MEDIUM FOR CACHING OBJECTS

(71) Applicants: Lemon Inc., Grand Cayman (KY); Douyin Vision Co., Ltd., Beijing (CN)

(72) Inventors: Hao LI, Los Angeles, CA (US); Ye XU, Los Angeles, CA (US); Yang YANG, Los Angeles, CA (US); Jian WANG, Beijing (CN)

(21) Appl. No.: 19/093,168

(22) Filed: Mar. 27, 2025

(51) Int. Cl. G06F 12/0802

(52) U.S. Cl. CPC G06F 12/0802; G06F 2212/60

(57) ABSTRACT

Embodiments of the present disclosure provide a method, device, and medium for caching an object. The method comprises obtaining object information of a set of objects. The method further comprises ranking, based on the object information, the set of objects according to a predetermined strategy, wherein the predetermined strategy includes at least a time factor and at least a space factor. In addition, the method further comprises caching objects with ranking positions being higher than the first threshold among the ranked objects for a hot object cache, wherein the hot object cache is suitable for an access of a client.

### BACKGROUND

CDN (Content Delivery Network) is a distributed network service that aims to reduce network latency, speed up content loading, and improve the overall performance and reliability of websites by deploying servers worldwide and caching content on servers closest to users. CDN uses intelligent routing and load balancing technology to ensure that users can access the required resources quickly and stably. When a user visits a website, CDN routes the request to the nearest server based on the user's geographic location. The server reads the content from the source server and caches it locally. Next time the user accesses the same content, CDN returns the content directly from the local server, reducing the time required to transfer content from the source server.

CDN is widely used in various scenarios that require fast and stable content access, such as video streaming, large websites, online games, e-commerce. In short, CDN effectively solves the bottleneck problem in internet content distribution through its distributed architecture and intelligent routing technology, and improves user experience and website performance.

### SUMMARY

In a first aspect according to some embodiments of the present disclosure, a method for caching an object is provided. The method comprises obtaining object information of a set of objects. The method further comprises ranking, based on the object information, the set of objects according to a predetermined strategy, wherein the predetermined strategy includes at least a time factor and at least a space factor. In addition, the method further comprises caching objects with ranking positions being higher than the first threshold among the ranked objects for a hot object cache, wherein the hot object cache is suitable for an access of a client.

In a second aspect according to some embodiments of the present disclosure, an electronic device comprising a memory and a processor is provided. The memory is configured to store computer instructions which, when executed by the processor, cause the processor to obtain object information of a set of objects. The instructions further cause the processor to rank, based on the object information, the set of objects according to a predetermined strategy, wherein the predetermined strategy includes at least a time factor and at least a space factor. In addition, the instructions further cause the processor to cache objects with ranking positions being higher than the first threshold among the ranked objects for a hot object cache, wherein the hot object cache is suitable for an access of a client.

In a third aspect according to some embodiments of the present disclosure, a non-transitory computer-readable medium is provided. The medium comprises instructions stored thereon which, when executed by a processor, cause the processor to obtain object information of a set of objects. The instructions further cause the processor to rank, based on the object information, the set of objects according to a predetermined strategy, wherein the predetermined strategy includes at least a time factor and at least a space factor. In addition, the instructions further cause the processor to cache objects with ranking positions being higher than the first threshold among the ranked objects for a hot object cache, wherein the hot object cache is suitable for an access of a client.

Any of the one or more above aspects in combination with any other of the one or more aspects. Any of the one or more aspects as described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows a schematic diagram of an existing CDN architecture;

FIG. 2 shows a schematic diagram of a new CDN architecture in multiple embodiments of the present disclosure;

FIG. 3 is a flow chart illustrating an example process of caching an object according to some embodiments of the present disclosure;

FIG. 4 is a schematic diagram of typical Count-Min Sketch table according to some embodiments of the present disclosure;

FIG. 5 is a flow chart illustrating an example process 500 of a predetermined strategy based on Count-Min Sketch according to some embodiments of the present disclosure;

FIG. 6 is a flow chart illustrating an example process 600 of a predetermined strategy based on a Space-Saving Stream according to some embodiments of the present disclosure;

FIG. 7 is a flow chart illustrating an example process 700 of caching hot objects according to some embodiments of the present disclosure;

FIG. 8 is a flow chart illustrating an example process of responding to a request of a client according to some embodiments of the present disclosure;

FIG. 9 is a flow chart illustrating an example process 900 of responding to a request of a client and caching new hot objects according to some embodiments of the present disclosure;

FIG. 10 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are an open-ended inclusion, namely, “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (including the data itself, and data acquisition, or usage) involved in the technical solutions should comply with the requirements of corresponding laws and regulations, and relevant stipulations.

As mentioned above, CDN is widely used, but CDN also has many shortcomings. One problem is low availability of CDN. The availability of CDN may be affected by many factors. For example, operator problems may cause network packet loss, affecting the availability of CDN, and insufficient bandwidth resources and incomplete regional coverage of small operators may also cause users to report problems such as freezing and unsmooth playback. In addition, regional nodes suffering from DDOS attacks may also cause short-term unavailability, affecting overall availability.

Another problem of CDN is high cost. Deploying and maintaining CDN networks requires a certain amount of investment, including server costs, bandwidth fees, and maintenance fees. For small websites or individual developers, this may be a considerable burden. And another problem of CDN is technical complexity. The deployment and management of CDN requires certain technical knowledge and experience. If improperly configured, it may lead to performance degradation or security issues.

Another problem is content update synchronization problem. Since CDN caches content, when updating website content, it is necessary to ensure that the cached content on CDN is also updated synchronously. If the update is not timely or there is a problem with synchronization, users may obtain outdated or incorrect information. And another problem is reliance on third-party services. CDN services are usually provided by third parties, which means that the performance and stability of the website depend to a certain extent on the reliability and stability of these service providers. If there is a problem with the CDN service provider, it may affect the normal operation of the website.

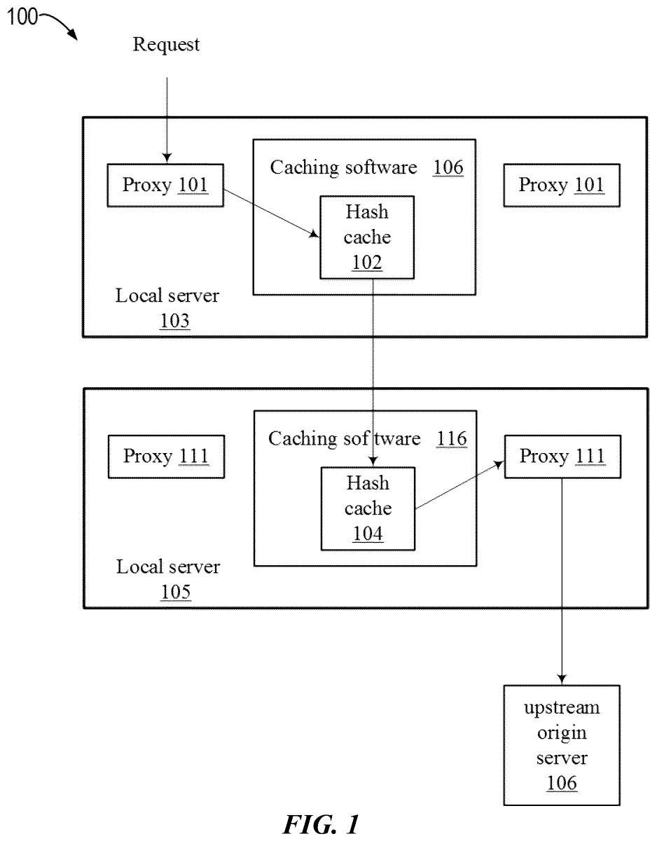

FIG. 1 shows a schematic diagram of an existing CDN 100 architecture. In the architecture, the proxy 101 receives a request for an object which may be stored in a hash cache disk 102 in a local server 103 from a client. The object may be a hot video or a hot image. CDN 100 may search the object in a hash cache disk 102. If the object is available in the hash cache disk 102, CDN 100 may send the object to the client and complete the user's request. Otherwise, CDN 100 may further search the object in another hash cache disk 104 in another local server 105. In the same way, if the object is available in the hash cache disk 104, CDN 100 may send the object to the client and complete the user's request. Otherwise, CDN may traverse all its servers to retrieve the object. If the object is not available in all the servers of CDN 100, CDN 100 may send a request to an upstream origin server 106 for the object. In this way, CDN 100 can fulfill large number of requests from clients. And the caching software 106, 116 etc. manage the caching in local servers.

However, one main problem with the current CDN architecture is that all objects are cached indiscriminately in the hash cache disks of CDN. When a large number of users access certain objects, there may be a large number of access delays or access anomalies, and even extreme cases of user access denial. This leads to a very poor user experience. In addition, caching all objects indiscriminately also brings about a waste of resource, which easily leads to hot objects not getting corresponding resources, while some objects that are not frequently accessed statically occupy too many resources. In addition, CDN cannot locate the requested object at a faster speed and needs to traverse its servers to find the requested object, which also wastes a lot of computing resources and cache resources.

More specifically, in addition to the cost concerns etc., there were several caching software specific issues that would impact the whole caching service. One issue is the present hot object detection algorithms had certain limitations that would lead to out of memory issues. And another issue is disk write saturations. The present caching architecture still had a sub-optimal cache hit rate. And another issue is the intranet traffic, which is the traffic inside CDN (e.g., if there is a cache miss at the local cache, there will be a request to the Hash Cache to fetch the object), is still high, which caused daily pains for the operators as a result of overloading the intranet bandwidth. Sometimes, a single host gets overloaded because a supper hot object fetching from the hash cache, due to the present sub-optimal hot object detection algorithm, and a few other performance metrics such as throughput (bps) per CPU core, disk read IO still had room for improvement for present CDN.

Therefore, it can be seen that a method or system is needed to solve at least one of the above multiple problems. The present disclosure proposes a method, device, system, medium, etc. for ranking or caching objects. Exemplarily, the embodiments of the present disclosure provide a scheme for ranking and caching objects, and furthermore, the embodiments of the present disclosure may design and develop a mechanism to take care of at least one of the above issues. That is, new hot object detection algorithms that has more accurate predictions for hot objects has been proposed in this disclosure. And a new caching layer structure has also be proposed, which is called the in-memory cache layer in front of a local cache layer, to take advantage of the local memory to cache hot objects. And a new hot object caching strategy has also been proposed to let certain hot objects enter or to be evicted from the in-memory cache and local cache.

More specifically, a method of the embodiments of the present disclosure may be provided for caching an object. The method may obtain object information of a set of objects. And based on the object information, the method may rank the set of objects according to a predetermined strategy, wherein the predetermined strategy includes at least a time factor and at least a space factor. Then the method further cache objects with ranking positions being higher than the first threshold among the ranked objects for a hot object cache, wherein the hot object cache is suitable for an access of a client.

In this way, by ranking the set of objects among the objects according to a predetermined strategy and caching objects with ranking positions being higher than the first threshold among the ranked objects for a hot object cache, the cost of CDN will be reduced. Furthermore, the hit rate of access requests is improved, thereby greatly improving the user experience. In addition, the use of the method and architecture disclosed in the present invention greatly improves the utilization of resources such as cache, CPU, disk read IO and bandwidth etc., thereby making the CDN of the present disclosure more efficient.

Next, multiple embodiments of the present disclosure will be described in detail with reference to the relevant drawings. Before describing the multiple embodiments of the present disclosure in detail, relevant terms and their meanings that may be used in the multiple embodiments will be first introduced.

### Terminology

POP (Cluster) Point of Presence: This refers to edge infrastructure (proxy, caching, and other services) that handle viewer requests before the requests are forwarded to the origin servers. POP and Cluster are interchangeable here.

Origin Server: This refers to Infrastructure that hosts the contents. A cache miss in the POP layers will result in an origin server visit (will hit the origin Shield first). Exemplarily, contents may be hosted in several data centers in Virginia (VA) USA, Singapore (SG), and may be expanded to Malaysia (MY), Ireland (IE) and Norway (NO) etc.

Origin Shield: This refers to a special set of caching servers sitting right in front of the origin servers. The main use of shield is to protect origins from malicious usage (therefore the name), but they do provide some level of caching as well.

Regional Edge Cache: This refers to the secondary layer that Edge Caching cluster routes to after the first layer of Caching cluster experiences a cache miss. Regional POP has the same architecture as the first layer, but it generally has a larger cache width.

In-memory Cache: This refers to a cache layer sitting in front of a local cache, usually the first layer of caching to serve viewer requests by leveraging its local memory.

Local (Disk) Cache: This refers to a cache layer that sits behind the in-memory cache and before the hash cache, leveraging its local disk (a small percentage of the disk space) to handle the request. A cache miss in the in-memory cache will result in a local cache visit.

Hash (Disk) Cache: This refers to a distributed cache layer that uses the entire cluster (POP)'s machines' disk (a large percentage of the disk space of each machine) to handle the request. A cache miss in the local cache will result in a hash cache visit.

Cache Hit/Miss Rate: For each cache layer, if the requested object is in the cache and has not yet expired, the server will return this object back to the viewer and it is called a cache hit, otherwise it is a cache miss. The hit rate is the ratio of the requests that result into a cache hit on each layer and/or the overall edge layers.

Hot Object: In the Internet, Hot Objects usually refer to resources or objects that become very popular due to frequent user access. These objects may be web pages, pictures, videos, database records, etc. They become hot spots in the system due to high traffic, which puts higher requirements on system performance and resource management.

Hot Object Caching: This refers to a caching mechanism that determines whether each requested object is “hot” or not; if it is hot, it will be cached in the local cache and In-memory Cache layers.

Cache-fill: This refers to the amount of traffic that a CDN cache server needs to fetch from its upstream (another layer of cache, or the Origin server), in order to serve an edge request.

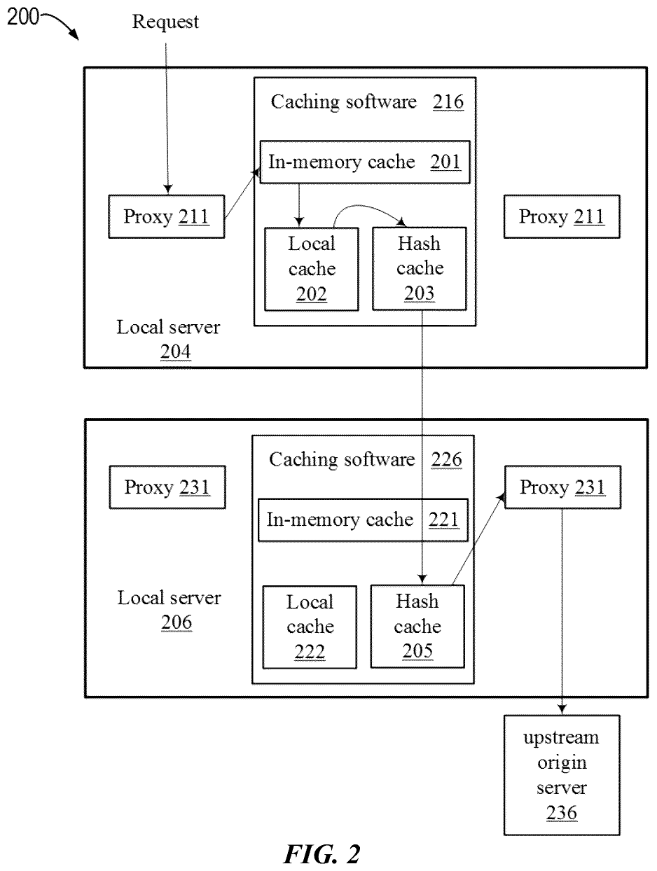

FIG. 2 shows a schematic diagram of a new CDN architecture 200 in multiple embodiments of the present disclosure. Multiple embodiments of the present disclosure can be implemented in the new CDN architecture 200. As shown in FIG. 2, the proxy 211 receives a request for an object which may be stored in an in-memory cache 201, a local cache 202 or a hash cache 203 in a local server 204 from a client. The object may be a video, an image, a document, an electronic coupon or a software application, the object may be hot or not. CDN 200 may determining whether the object is hot or not according to according to a predetermined strategy of the present disclosure, wherein the predetermined strategy includes at least a time factor and at least a space factor. In response to the determining, CDN 200 may respectively retrieve the object in the in-memory cache 201, the local cache 202 or the hash cache 203. If the object is available in the in-memory cache 201, the local cache 202 or the hash cache 203, CDN 200 may send the object to the client and complete the user's request. Otherwise, CDN 200 may further search the object in another hash cache disk 205 in another local server 206. In the same way, if the object is available in the hash cache disk 205, CDN 200 may send the object to the client and complete the user's request. Otherwise, CDN may traverse all its servers to retrieve the object. If the object is not available in all the servers of CDN 200, CDN 200 may send a request to an upstream origin server 236 for the object. Furthermore, CDN 200 may let certain hot objects enter or to be evicted from the in-memory cache and local cache. CDN 200 may further rank the objects of local servers and cache the hottest objects in the in-memory caches and cache the hot objects in the local caches respectively. And the caching software manage the caching in local servers. And how the cache software 216, 226 etc. specifically manages the caching will be described in detail in the subsequent multiple embodiments of the present disclosure.

In this way, CDN 200 can save cost, fulfill requests from clients with high efficiency and high Quality of Service (QoS). And CDN 200 also can greatly improves the utilization of resources such as cache, CPU, disk read IO and bandwidth etc. In short, CDN 200 of the present disclosure has great advantage over the traditional CDN 100.

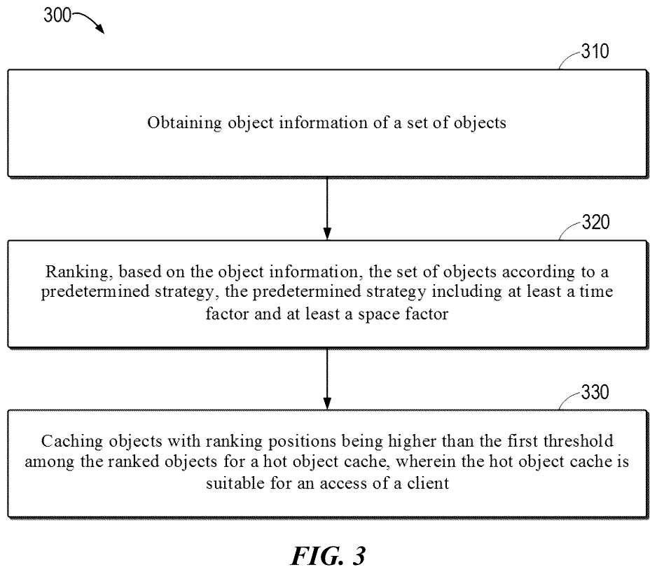

FIG. 3 is a flow chart illustrating an example process 300 of caching an object according to some embodiments of the present disclosure. The example process 300 may be implemented by a computing device, the computing device may be a server (e.g., the server 204 in FIG. 2), or by a high level management application running on CDN 200 etc. The present disclosure does not specifically limit the specific implement of the process 300. Any suitable implement of process 300 for the present disclosure should be within the protection scope of the present disclosure. As shown in FIG. 3, at block 310, the computing device may obtain object information of a set of objects. For example, as shown in FIG. 2, the server 204 may obtain the object information from the objects cached in the in-memory cache 201, the local cache 202, or even the hash cache 203. The object information of the set of objects may comprise an address of the object, time limitation, space limitation or a hit counter within the time limitation. Exemplarily, the time limitation may be limited to a time threshold, and the time threshold may be determined by the skilled person in the art according to his/her experience. And the time limitation threshold may be 2 days, 3 days, one week, or even two weeks. The present disclosure does not specifically limit the specific threshold of the time limit. Any time threshold suitable for the present disclosure should be within the protection scope of the present disclosure. The space limitation may be set to be limited within the local server, such as within server 204. If necessary, the space limitation may be extended to the nearby servers, such as the local server 206. The hit counter within the time limitation may record the hit count of the object within the time limitation. Alternatively, the server 204 can also select the objects with high hit count according to the log information stored in the server 204.

At block 320, based on the object information, the server 204 may rank the set of objects according to a predetermined strategy, and the predetermined strategy includes at least a time factor and at least a space factor. Alternatively, the factors of the predetermined strategy may satisfy a value of the time factor being within a time threshold or the space factor being limited to a local server. Regarding how to formulate and implement the predetermined strategy, this present disclosure will be described in detail in the following multiple embodiments.

At block 330, the server 204 may cache objects with ranking positions being higher than the first threshold among the ranked objects for a hot object cache, wherein the hot object cache is suitable for an access of a client. Exemplarily, the hot object cache may comprise two-layer caches, the first layer is an in-memory cache (e.g., the in-memory cache 201), and the second layer is a local cache disk (e.g., the local cache 202), and alternatively, the in-memory cache may be a part of a memory of the local server 204. Furthermore, the objects with ranking positions being higher than the first threshold may be taken as the hot objects, and they may be cached in the in-memory cache 201 or the local cache 202. Alternatively, the objects with ranking positions being higher than the third threshold may be cached in the in-memory cache 201. As for how to setting the first threshold and the third threshold, this present disclosure will be described in detail in the following multiple embodiments related to the predetermined strategy. While the hot objects have been cached in the in-memory cache 201 or the local cache 202, the other objects of the set of objects may be cached in in at least one hash cache disk (e.g., the hash cache 203) which is located in the local server 204.

In this way, by ranking the set of objects among the objects according to a predetermined strategy and caching objects with ranking positions being higher than the first threshold among the ranked objects for a hot object cache, the process 300 can reduce the cost of CDN 200. Furthermore, the hit rate of access requests is also improved, thereby greatly improving the user experience. In addition, the use of the process 300 greatly improves the utilization of resources such as cache, CPU, disk read IO and bandwidth etc., thereby making the CDN of the present disclosure more efficient.

Furthermore, a robust predetermined strategy to track which objects are hot in the local server is introduce in this present disclosure. Upon cache miss on local cache, local caching deployment will forward the request of the client to a remote caching deployment (the hash cache layer). The routing is determined by a cache key, which is computed based on the request's domain URL and URI path. This ensures that the requests with the same content will always be routed to the same remote caching deployment. The predetermined strategy is designed to monitor which objects are to be written into the hot object cache (In-memory cache or local cache), and the predetermined strategy may operate in one of two modes, each utilizing different data structures. One data structure may be based on a Count-Min Sketch. Alternatively, another data structure may be based on a Space-Saving Stream.

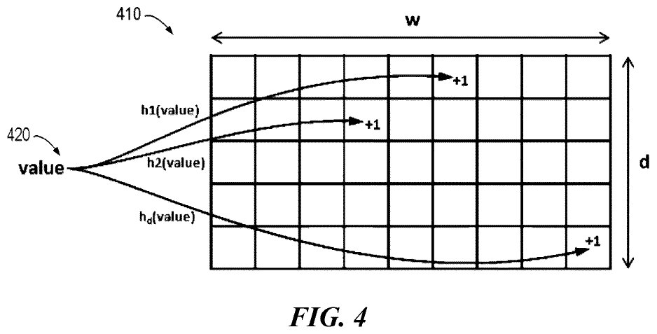

FIG. 4 is a schematic diagram of typical Count-Min Sketch table according to some embodiments of the present disclosure. Generally speaking, Count Min Sketch is a statistical algorithm, whose goal is to be able to track each object count while keeping the cardinality of the table static. Keeping this table static would prevent caching servers from running out of memory, an issue that occurred for the traditional caching servers. This algorithm achieves this by utilizing collision resistant hashes. As FIG. 4 shows, initialization involves identifying at least one distinct hash function and setting up a two-dimensional array 410 with w columns and d rows, wherein the w columns indicate the hashed index, and the d rows indicate the types of hash functions (e.g. h1, h2, h_{d} etc. as shown in FIG. 4), this is, if there are two different hash functions used, then d equals 2, and if there are three different hash functions used, then d equals 3. To increment a requested value of one of the objects, calculate the hashes of the value 420 and then increment the value 420 at the corresponding hashed index by 1. To obtain the count of the requested value, retrieve the values at all the hashed indices and return the minimum of these values.

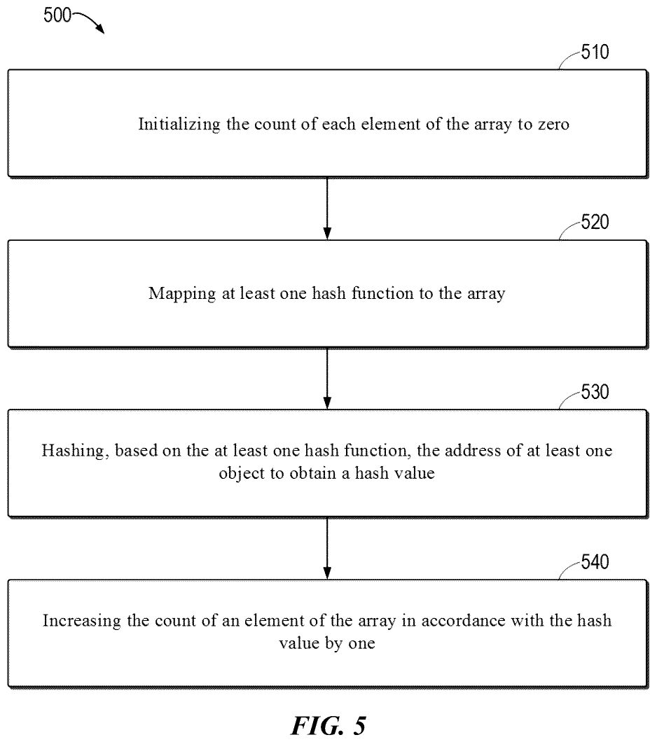

More specifically, FIG. 5 is a flow chart illustrating an example process 500 of a predetermined strategy based on Count-Min Sketch according to some embodiments of the present disclosure. At block 510, an array may be created. As mentioned above, the array may be One-dimensional array if only one hash function is used. Alternatively, the array may be a two-dimensional array 410 with w columns and d rows, wherein the w columns indicate the hashed index, and the d rows indicate the types of hash functions (e.g. h1, h2, h_{d} as shown in FIG. 4), this is, if there are two different hash functions used, then d equals 2, and if there are three different hash functions used, then d equals 3. The hashed index may be the hash key of the address of the objects, and the hash key may be normalized, or Hash keys may be natural numbers. By using the created array, the hit counts of the objects may be recorded, then the recorded hit counts may be used for ranking to determine the hot objects. At block 520, the count of each element of the array may be initialized to zero. That is, before recording the value of the objects, the array needs to be initialized to zero. Otherwise the value may not reflect the actual hits of the objects. Then at block 530, at least one hash function is mapped to the array, and at block 540, based on the at least one hash function, the address of at least one object may be hashed to obtain a hash value. Through the steps at blocks 530 and 540, the objects are associated with the array respectively. As shown in FIG. 4, each block of the array 410 (or Count-Min Sketch table) represents one object with a specific hash function. Then at block 550, the count of an element of the array in accordance with the hash value may be increased by one if the object is hit. Through repeating the step of block 550, the ranking array 410 will be built for the objects.

Furthermore, if the hit frequency of an object is need, it just needs return the count of the array position corresponding to the hash of the object. The skilled person in the art may determine the first threshold for the ranking position according to related experiments or experience. For an example, the first threshold may be set as 10,000, which means only the top 10,000 ranked objects can be considered as a “hot” object in the local server. The objects among the ranked objects with hit counts being higher than the first threshold may be labeled as hot objects and they may be cached in the hot cache accordingly. It should be understood that the present disclosure doesn't limit the scope of the first threshold. Any value of the first threshold being proper for the present disclosure is suitable, and they are also fall in the scope of the present disclosure.

In this way, by ranking the set of objects among the objects according to a predetermined strategy based on Count Min Sketch algorithm and caching objects with ranking positions being higher than the first threshold among the ranked objects for a hot object cache, the process 500 can reduce the cost of CDN 200. Furthermore, the hit rate of access requests is also improved, thereby greatly improving the user experience. In addition, the use of the process 500 greatly improves the utilization of resources such as cache, CPU, disk read IO and bandwidth etc., thereby making the CDN of the present disclosure more efficient.

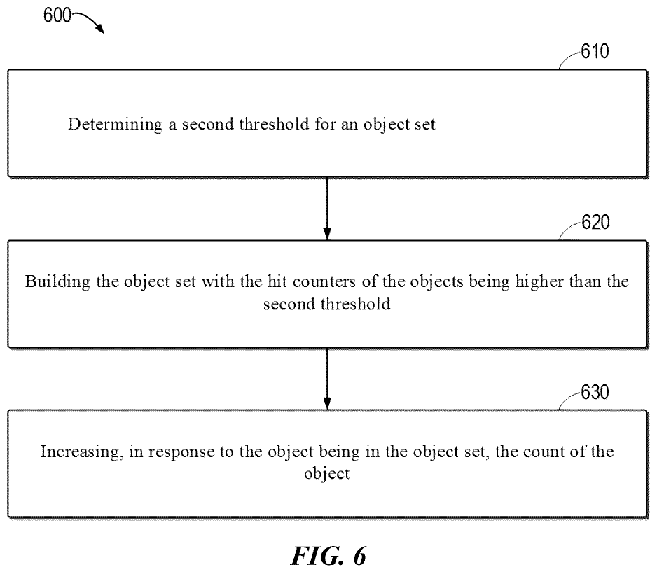

Alternatively, another predetermined strategy may be based on Space-Saving Stream. FIG. 6 is a flow chart illustrating an example process 600 of a predetermined strategy based on a Space-Saving Stream according to some embodiments of the present disclosure. The Space-Saving Stream algorithm is an approximate counting method for large data that aims to reduce memory usage. Space Saving Stream's goal is to be able to track just the top hit objects. The algorithm uses a list of hit counters, and replaces the item with the lowest counter when a new requested item arrives. The predetermined strategy based on a Space-Saving Stream is described in detail below with reference to FIG. 6. At block 610, a second threshold of hit counter is determined for the objects. The skilled person in the art may determine the second threshold for the objects according to related experiments or experience. exemplarily, the second threshold may be set as 15,000, which means only the top 15,000 objects with the highest hit counters can be considered as hot objects. The objects with hit counts being higher than the second threshold may be labeled as hot objects and they may be put in a set of hot objects. The original set of hot objects may be determined based on the log records of the objects. It should be understood that the present disclosure doesn't limit the scope of the second threshold. Any value of the second threshold being proper for the present disclosure is suitable, and they are also fall in the scope of the present disclosure.

At block 620, an object set with the hit counters of the objects may be built, and the hit counts of the objects are all higher than the second threshold. That is, a set of hot objects has been built. Then at block 630, in response to the object being in the object set and the object is hit, the count of the object can be increased. By repeating the step of block 630, the ranking set of hot objects may be set up.

In some implements, the predetermined strategy may further comprise adding, in response to an object with hit counters of the objects being higher than the second threshold and the object set being not full, the object to the object set.

Alternatively, in some implements, the predetermined strategy may further comprise removing, in response to an object with hit counters of the object being higher than the second threshold and the object set being full, an object with the smallest counter value in the object set to insert the object with hit counters of the object being higher than the second threshold to the object set. In this way, the predetermined strategy can remove the objects becoming cold.

In this way, by ranking the set of objects among the objects according to a predetermined strategy based on Space-Saving Stream algorithm and caching objects with ranking positions being higher than the first threshold among the ranked objects for a hot object cache, the process 600 can reduce the cost of CDN 200. Furthermore, the hit rate of access requests is also improved, thereby greatly improving the user experience. In addition, the use of the process 600 greatly improves the utilization of resources such as cache, CPU, disk read IO and bandwidth etc., thereby making the CDN of the present disclosure more efficient.

To sum up, the newly introduced mechanisms of the present disclosure gives above two predetermined strategies for Site Reliability Engineers (SREs) to tune and adjust accordingly to the cluster's traffic data patterns. The predetermined strategy based on Count Min Sketch can be used when SREs wish to configure a static Queries Per Second (QPS) threshold, and the predetermined strategy based on Space Saving Stream can be used when SREs wish to automatically track top hot objects instead. Both predetermined strategies also consider the CPU limits that on the server clusters and have constant and bounded memory usage.

Alternatively, some embodiments of the present disclosure may leverage Exponentially Weighted Moving Average (EWMA) to decay the QPS counters and prioritize newer data points. This is, the both predetermined strategies are further based on EWMA to decay hit counters of the object overtime. EWMA is a statistical method used to estimate the smoothed round-trip time (RTT) and adjust the retransmission timeout (RTO). EWMA uses exponentially weighted moving average to dynamically adjust the RTO to adapt to different network environments by combining information from all previous subgroups or observations. This method can smooth fluctuations in network delay and improve transmission efficiency

Exemplarily, the decaying mechanism of EWMA may be used for the results of the predetermined strategy based on Space-Saving Stream and the predetermined strategy based on Count-Min Sketch. In these cases, the EWMA is utilized to decay the counters considering the time factor. The EWMA, may be calculated by formula (1) as following:

$${EWMA}_{t} = α {X}_{t} + ( 1 - α ) {EWMA}_{t - 1} \qquad ( 1 )$$

Wherein EWMAₜ means the adjusted counter value in time t, and a is the smoothing factor, and Xₜ means the present hit counts in time t.

We define half-life t_{1/2} here as the time it requires for a statistical value to reach half of its original value, and this half-life time window can be toggled by tuning a, the smoothing factor as formula (2) as following:

$$α = {2}^{- 1 / {t}_{1 / 2}} \qquad ( 2 )$$

The reason implementing this decay formula for both the predetermined strategies is because more recent statistical data are need to have more influence than older data points as they are more relevant in predicting incoming traffic. How much more emphasis we put on recent data points can be adjusted with the smoothing factor α, and this is a parameterized variable for each caching POP, as different regions have different traffic patterns and user behavior. In this way of EWMA, the hit efficiency will be improved greatly, and the user experience will be improved greatly accordingly.

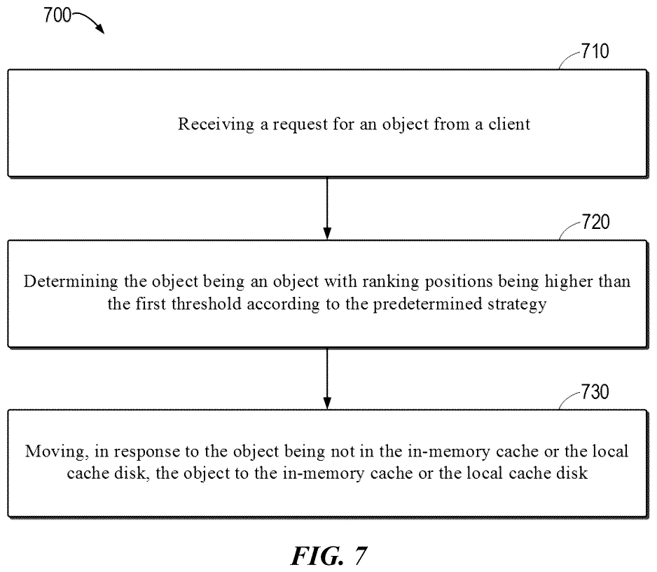

FIG. 7 is a flow chart illustrating an example process 700 of caching hot objects according to some embodiments of the present disclosure. As mentioned above, the hot object cache comprises two-layer caches, the first layer is an in-memory cache, and the second layer is a local cache disk, and the in-memory cache is a part of a memory of a local server. The process 700 is used to determining how to caching the hot objects for the two-layer caches. At block 710, a request for an object is received from a client. Exemplarily, the object may be a video, an image, a document, an electronic coupon or a software application, the object may be hot or not. At block 720, according to the predetermined strategy, the object is determined as an object with ranking positions being higher than the first threshold. The predetermined strategy may be the strategy based on Count Min Sketch algorithm or the strategy based on Space-Saving Stream algorithm. That is, as noted above, the object is a hot object.

At block 730, in response to the object being not in the in-memory cache or the local cache disk, the object is determined to be cached to the in-memory cache or the local cache. As mentioned above, the new local caching layer and the new in-memory cache layer have been introduced into multiple embodiments of the present disclosure. The two layers primarily utilizes RAM to store recently and frequently requested data. The size of the memory for each POP's in memory Cache is a parameter that SREs can configure during runtime. The example process 700 may further cache the objects with ranking positions being higher than the third threshold for the in-memory cache. Exemplarily, the third threshold may be set as 5,000, which means only the top 5,000 of the ranked objects can be considered as the top hot objects. The objects with hit counts being higher than the third threshold may be labeled as top hot objects and they may be cached in the in-memory cache. It should be understood that the present disclosure doesn't limit the scope of the third threshold. Any value of the third threshold being proper for the present disclosure is suitable, and they are also fall in the scope of the present disclosure.

The in-memory caching strategy based on the predetermined strategies may be combined with the implementation of Least Recently Used (LRU) eviction algorithm. In practice, LRU may be a popular caching algorithm. This algorithm ensures optimal utilization of the available memory by discarding the least recently accessed items first when the cache reaches its capacity limit. The LRU mechanism is particularly effective in maintaining a cache that aligns closely with the current access patterns, thereby maximizing the hit rate and efficiency of the cache.

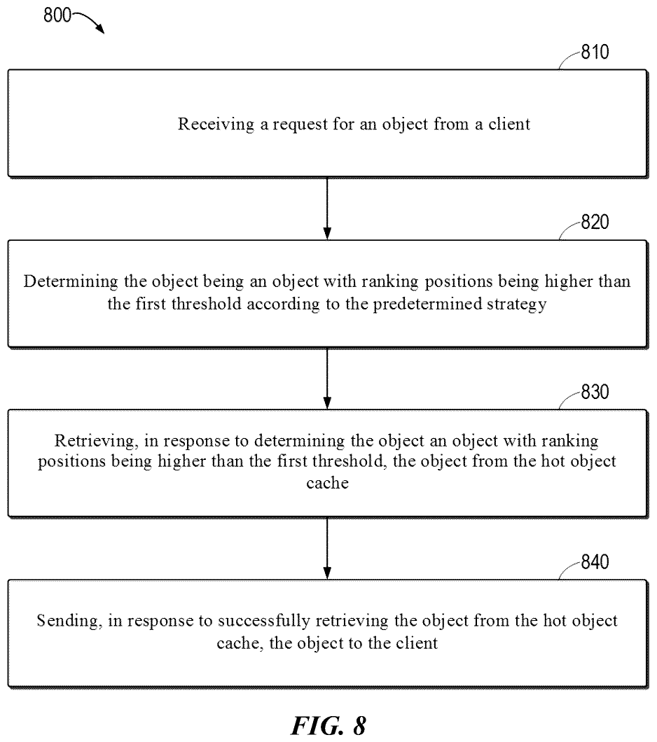

Alternatively, FIG. 8 is a flow chart illustrating an example process 800 of caching hot objects in the local cache according to some embodiments of the present disclosure. The process 800 is aimed to move the new hot objects from the origin server. At block 810, in response to failing to retrieve the object from the in-memory cache, a local cache disk or the hash cache disk, the object requested by the user is fetched from an origin server. That is, the object requested by the user is not available in the local servers 204, 206 etc., then the object need to be obtained from the origin server and be fetched. At block 820, the object is determined as being an object with ranking positions being higher than the first threshold according to the predetermined strategy. The predetermined strategy may be the strategy based on Count Min Sketch algorithm or the strategy based on Space-Saving Stream algorithm as mentioned above. That is, the object is determined as a hot object according to the predetermined strategy. Then at block 830, in response to the object being an object with ranking positions being higher than the first threshold, the hot object is moved to the local cache disk. In this way, the hit efficiency of the new hot objects is also improved greatly.

To sum up, the caching architecture of CDN 200 of multiple embodiments of the present disclosure integrated a multi-layered caching strategy across each POP to optimize content delivery. This caching strategy is a combination of local in-memory cache, local cache, and hash Cache layers, each playing a pivotal role in ensuring efficient content retrieval and storage.

In some implements, the local in-memory cache has characteristics of high speed, low latency and limited space. The objective of the local in-memory cache is to store and serve the most frequently and recently accessed data rapidly. And the local in-memory cache based on both the predetermined strategies is used to identify the most frequently accessed data, which is beneficial for a highspeed cache. However, it might not always reflect the most recent access patterns. Then the LRU algorithm may be used as a beneficial supplementary algorithm for the local in-memory cache based on both the predetermined strategies. The LRU algorithm may efficiently utilize limited space by keeping the most recently used data and discarding the least recently accessed when space is needed. This aligns well with the requirement for rapid access to current popular content.

In some implements, the local cache (Disk Cache) has characteristics of larger capacity and slower access compared to the in-memory cache. The objective of the local cache is to provide a broader range of content storage and act as a backup for the in-memory cache, the local cache based on both the predetermined strategies can be effective for identifying hot objects within a given timeframe that are worth storing in a larger, but slower, cache. This ensures that frequently requested content is more likely to be available in the local cache. Then the LRU algorithm may be used as a beneficial supplementary algorithm for the local cache based on both the predetermined strategies. The LRU algorithm may be especial for managing the cache space efficiently. However, its focus on recent access might lead to frequent changes in stored content, which can be less efficient due to the slower nature of disk-based storage.

In some implements, the hash cache has characteristics of tertiary level cache, with a much bigger disk capacity to store contents/objects. The objective of the hash cache is to cache and store content missed by the first two layers, i.e., the local in-memory cache and the local cache, acting as an intermediate before requesting from upstream/origin. The hash cache is useful for identifying the content missed by the first two layers, and is also significantly popular within a given timeframe and should be stored for future requests. However, the LRU algorithm may be less effective for the hash cache, as this layer is more about caching less frequently accessed data that might not be caught by the LRU mechanism in the primary caches.

FIG. 8 is a flow chart illustrating an example process 800 of responding to a request of a client according to some embodiments of the present disclosure. The example process 800 is used to meet the request of the client for an object if it is available on servers. At block 810, a request for an object from a client is received. Exemplarily, the object may be at least one of a video, an image, a document, an electronic coupon or a software application, and the object may be hot or not. The internet application route the request for an object from a client to CDN 200. And the hash key of the request is associated with the local server 204. Thus, the request is also routed to the local server 204 firstly.

At block 820, the object being an object with ranking positions being higher than the first threshold is determined according to the predetermined strategy. That is, the object is a hot object. Then at block 830, in response to determining the object an object with ranking positions being higher than the first threshold, the object is retrieved from the hot object cache. That is, because the object is hot object, so the object should be cached in the hot object cache, i.e., the local in-memory cache and the local cache. Therefore, the requested object can be retrieved from the local in-memory cache and the local cache. Usually, the object may be retrieved in the local in-memory cache firstly, if missed, the object may be retrieved from the local cache. And at block 840, in response to successfully retrieving the object from the hot object cache, the object may be sent to the client. That is, the requested object by the client has been met and a successful message may be sent to the high-level management applications.

In some implements, the example process 800 may further access, in response to failing to retrieve the object from the hot object cache, at least one hash cache disk. And the example process 800 may further retrieve the object from the at least one hash cache disk for the client. That is, if the requested object by the client is not a hot object, it means the may not be cached in the hot object cache. Thus, the example process 800 have to search the local hash cache to retrieve the requested object. If the requested object is also not in the local hash cache, the example process 800 have to search the hash cache in other servers in CDN 200. If still missing, the example process 800 have to retrieve the requested object from the upstream origin servers. Otherwise, the example process 800 have to report the failure message to the high-level management applications.

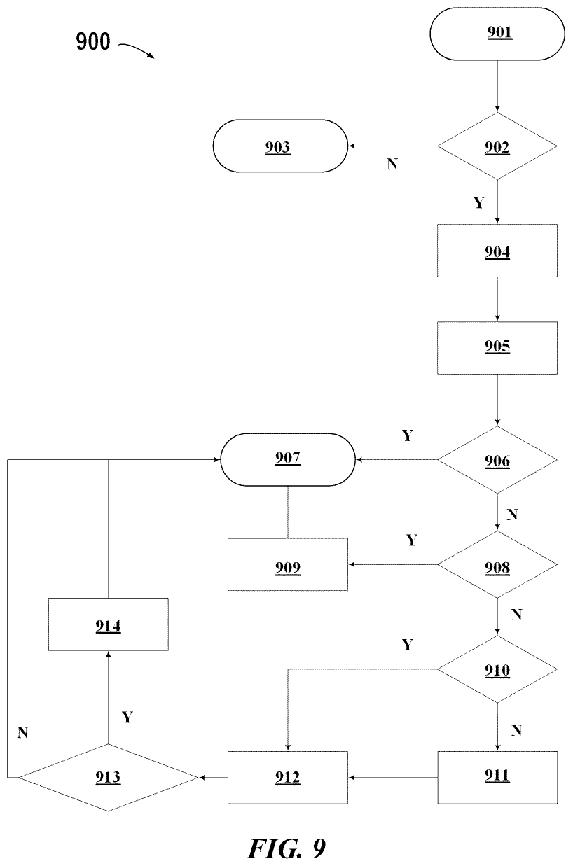

FIG. 9 is a flow chart illustrating an example process 900 of responding to a request of a client and caching new hot objects according to some embodiments of the present disclosure. The example process 900 is aimed to fulfill the request from the client and cache new hot objects in the three-layer caching mechanism (i.e., the local in-memory cache, the local cache and the hash cache) of multiple embodiments of the present disclosure. In practice, the good approach might involve a combination of the determined strategy and the LRU algorithms at each cache layer, tailored to the specific dynamics of the content and access patterns observed in the CDN. Regular monitoring and adjustments based on empirical data would be essential for optimal cache performance.

When a new request 901 for an object from a client arrives at a POP (e.g., CDN 200), the request 901 may be checked at block 902. If the request 901 is a malicious attack request, the request will be refused and a failure response may be sent at block 903. If the request 901 is a normal request from the client, the request 901 may be handled at block 904. At block 904, the request 901 may be analyzed based on the predetermined strategy as mentioned above. Then the requested object of the request 901 may be determined as a hot object or not. Then the storage engine of the POP may route the request 901 to different caching layers (i.e., the local in-memory cache, the local cache and the hash cache) at block 905.

At block 906, the local in-memory cache may be the first checkpoint. This layer, optimized for speed through the use of RAM, may immediately serve the content if it's present (a cache hit), and the hit object will be sent to the client and a successful message may be sent to the high-level management applications at block 907. In the event of a cache miss, that is, the requested object is not in the local in-memory cache, the request progresses to the local cache layer at block 908. This secondary layer of local cache may be implemented on disk storage and provides a larger content repository. If the object/content is found here (a cache hit), it's not only served but also backpropagated to the in-memory cache at block 909, adhering to the LRU eviction algorithm. That is, if hit, at block 909, the hit object may be moved to the local in-memory cache rather than cached in the secondary layer of local cache. This ensures that Frequently accessed data remains readily available in the faster In-memory cache. Then, in response to the action of block 909, the hit object will be sent to the client and a successful message may be sent to the high-level management applications at block 907.

Should the request 901 fail to retrieve data from the local cache layer at block 908, it then moves to the local hash cache layer of the local server or other hash cache layer in other servers in the POP at block 910. The hash cache acts as a tertiary layer of caching, storing a much bigger width of subset of content, as mentioned above. In cases where the hash cache also results in a miss, the request 901 is finally directed to the upstream origin servers, either the Regional Echomail Coordinator (REC) or the origins, at block 911. The object fetched from the upstream origin server is first stored in the hash cache. However, whether it's stored in the local cache is determined by the predetermined strategy of block 912 as mentioned above at block 913, which identifies ‘hot’ objects based on access frequency and patterns. Hot objects are then cached in the local cache for quicker future access at block 914. Whether the fetched object is hot or not, the fetched object will be sent to the client and a successful message may be sent to the high-level management applications at block 907. This layered caching approach, combining the speed of In-memory caching with the comprehensive storage of the local and hash caches, and governed by intelligent algorithms like the predetermined strategy as mention above and LRU, ensures that CDN delivers content in the more efficient manner. It significantly reduces latency, minimizes origin server load, and provides a scalable solution to handle varying traffic patterns and content popularity dynamics. This results in an enhanced user experience, characterized by rapid content delivery and high availability.

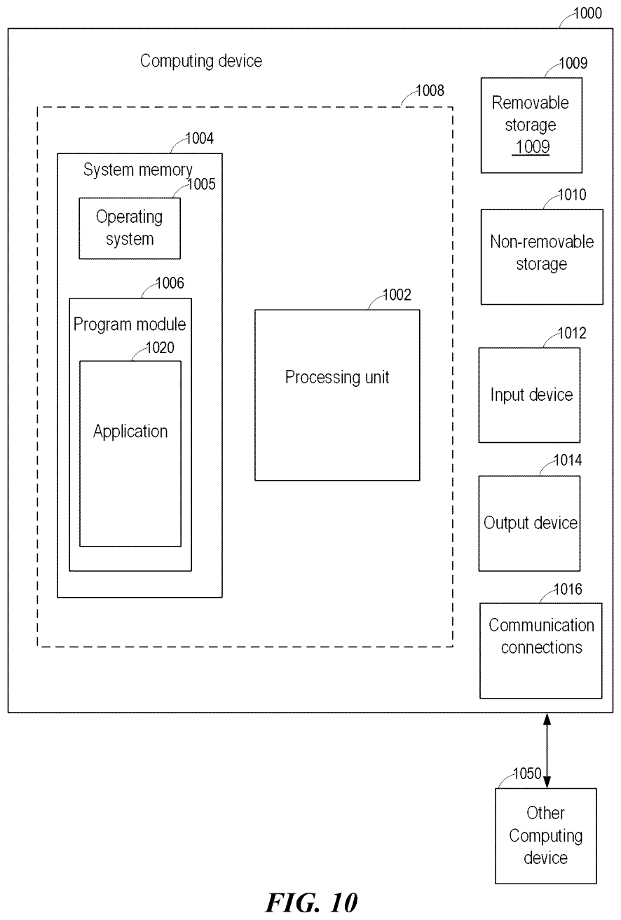

FIG. 10 is a block diagram illustrating physical components (e.g., hardware) of an electronic device 1000 with which aspects of the disclosure may be practiced. For example, the electronic device 1000 may implements the processes as depicted in FIGS. 3, 5-9. In a basic configuration, the processing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories.

The system memory 1004 may include an operating system 1005 and one or more program modules 1006 suitable for performing the various aspects disclosed herein such. The operating system 1005, for example, may be suitable for controlling the operation of the processing device 1000. Furthermore, aspects of the disclosure may be practiced in conjunction with other operating systems, or any other application program and is not limited to any particular application or system. This basic configuration is illustrated in FIG. 10 by those components within a dashed line 1008. The processing device 1000 may have additional features or functionality. For example, the processing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, several program modules and data files may be stored in the system memory 1004. While executing on the at least one processing unit 1002, an application 1020 or program modules 1006 may perform processes including, but not limited to, one or more aspects, as described herein. The application 1020 may include an application interface 1021 which may be the same as or similar to the application interface 1021 as previously described in more detail with regard to FIGS. 3, 5-9. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 500 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The processing device 500 may include one or more communication connections allowing communications with other computing or processing devices 1050. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 1000. Any such computer storage media may be part of the processing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for caching an object, comprising:
obtaining object information of a set of objects;
ranking, based on the object information, the set of objects according to a predetermined strategy, the predetermined strategy including at least a time factor and at least a space factor; and
caching objects with ranking positions being higher than the first threshold among the ranked objects for a hot object cache, wherein the hot object cache is suitable for an access of a client.

2. The method according to claim 1, wherein the factors of the predetermined strategy satisfy at least one of following:
a value of the time factor being within a time threshold; or
the space factor being limited to a local server.

3. The method according to claim 1, wherein the object information of the set of objects comprises at least one of the following:
an address of the object;
time limitation;
space limitation; or
a hit counter within the time limitation.

4. The method according to claim 3, wherein the predetermined strategy comprises:
creating an array;
initializing the count of each element of the array to zero;
mapping at least one hash function to the array;
hashing, based on the at least one hash function, the address of at least one object to obtain a hash value; and
increasing the count of an element of the array in accordance with the hash value by one.

5. The method according to claim 1, wherein the predetermined strategy comprises:
determining a second threshold for an object set;
building the object set with the hit counters of the objects being higher than the second threshold; and
increasing, in response to the object being in the object set, the count of the object.

6. The method according to claim 5, wherein the predetermined strategy further comprises:
adding, in response to an object with hit counters of the objects being higher than the second threshold and the object set being not full, the object to the object set; or
removing, in response to an object with hit counters of the object being higher than the second threshold and the object set being full, an object with the smallest counter value in the object set to insert the object with hit counters of the object being higher than the second threshold to the object set.

7. The method according to claim 1, wherein the hot object cache comprises two-layer caches, the first layer is an in-memory cache, and the second layer is a local cache disk, and the in-memory cache is a part of a memory of a local server.

8. The method according to claim 7, the method further comprising:
caching other objects in at least one hash cache disk which is located in a local server.

9. The method according to claim 8, the method further comprising:
receiving a request for an object from a client;
determining the object being an object with ranking positions being higher than the first threshold according to the predetermined strategy; and
moving, in response to the object being not in the in-memory cache or the local cache disk, the object to the in-memory cache or the local cache disk.

10. The method according to claim 9, the method further comprising:
fetching, in response to failing to retrieve the object from the in-memory cache, a local cache disk or the hash cache disk, the object from an origin server;
determining the object being an object with ranking positions being higher than the first threshold according to the predetermined strategy; and
moving, in response to the object being an object with ranking positions being higher than the first threshold, the object to the local cache disk.

11. The method according to claim 8, the method further comprising:
receiving a request for an object from a client;
determining the object being an object with ranking positions being higher than the first threshold according to the predetermined strategy;
retrieving, in response to determining the object an object with ranking positions being higher than the first threshold, the object from the hot object cache; and
sending, in response to successfully retrieving the object from the hot object cache, the object to the client.

12. The method according to claim 11, the method further comprising:
accessing, in response to failing to retrieve the object from the hot object cache, at least one hash cache disk; and
retrieving the object from the at least one hash cache disk for the client.

13. The method according to claim 4, wherein the predetermined strategy is further based on at least two different hash algorithms.

14. The method according to claim 7, the method further comprising:
caching objects with ranking positions being higher than the third threshold for the in-memory cache.

15. The method according to claim 4, wherein the predetermined strategy is further based on exponential weighted moving average (EWMA) algorithms to decay hit counters of the object overtime.

16. The method according to claim 5, wherein the object comprises at least one of a video, an image, a document, an electronic coupon or a software application.

17. An electronic device, comprising:
a memory and a processor;
wherein the memory is configured to store one or more computer instructions which, when executed by the processor, cause the processor to:
obtain object information of a set of objects;
rank, based on the object information, the set of objects according to a predetermined strategy, the predetermined strategy including at least a time factor and at least a space factor; and
cache objects with ranking positions being higher than the first threshold among the ranked objects for a hot object cache, wherein the hot object cache is suitable for an access of a client.

18. The device according to claim 17, wherein the predetermined strategy comprises:
determining a second threshold of hit counter for the objects;
building an object set with the hit counters of the objects being higher than the second threshold; and
increasing, in response to the object being in the object set, the count of an object.

19. The device according to claim 17, wherein the hot object cache comprises two-layer caches, the first layer is an in-memory cache, and the second layer is a local cache disk, and the in-memory cache is a part of a memory of a local server.

20. A non-transitory computer-readable medium comprising instructions stored thereon which, when executed by a processor, cause the processor to:
obtain object information of a set of objects;
rank, based on the object information, the set of objects according to a predetermined strategy, the predetermined strategy including at least a time factor and at least a space factor; and
cache objects with ranking positions being higher than the first threshold among the ranked objects for a hot object cache, wherein the hot object cache is suitable for an access of a client.
